(19) United States
(12) Patent Application Publication
(10) Pub. No.: US 2018/0175655 A1
(43) Pub. Date: Jun. 21, 2018

(54) WIRELESS CHARGING DEVICE

(71) Applicant: Shenzhen Link Dream Electronic Technology Co., Ltd., Shenzhen (CN)

(72) Inventor: Hong Liu, Hunan Province (CN)

(21) Appl. No.: 15/414,163

(22) Filed: Jan. 24, 2017

(30) Foreign Application Priority Data
Dec. 16, 2016 (CN) 2016111710959

(51) Int. Cl. H02J 7/02; H02J 7/00

(52) U.S. Cl. CPC H02J 7/025; H02J 7/0044

(57) ABSTRACT

Provided is a wireless charging device, comprising a base, as well as a wireless charging circuit board and a first wireless charging module disposed in the base, the device further comprises: a support rod fixed by the base, and a charging stand supported by the support rod, and electrically connected to the wireless charging circuit board. The invention features a dual charging mode, and thus can charge different types of electric devices; particularly, it is possible to place a headset on the charging device, and to charge the headset wirelessly.

### TECHNICAL FIELD

The invention relates to the field of wireless charging technology, and more particularly to a wireless charging device.

### BACKGROUND

Wireless charging technology originates from wireless power transfer technology. Low power wireless charging often employs electromagnetic induction, in which a wireless charger is a device that charges portable electric devices (such as mobile phones) wirelessly. Since both the wireless charger and the electric device transfer power by a magnetic field, and no wire is used therebetween, neither the recharger nor the electric device has an exposed conductive contact. At present, the most popularly used type of wireless charger is a single-functional thin-plate-type wireless charger, but application range thereof is comparatively narrow.

### SUMMARY

In view of the above-mentioned problems, it is an objective of the invention to provide a wireless charging device with a dual charging mode that is capable of charging various types of electric devices, and thus particularly meeting requirements of a headset for wireless charging and placement.

In accordance with an exemplary embodiment of the invention, provided is a wireless charging device, comprising a base, as well as a wireless charging circuit board and a first wireless charging module disposed in the base, the device further comprises: a support rod fixed by the base, and a charging stand supported by the support rod, and electrically connected to the wireless charging circuit board.

Advantageously, the charging stand comprises:
a second wireless charging module operating to emit an electromagnetic field;
and
a support plate made of flexible glue and fixed on the second wireless charging module, an area thereof being greater than a surface area of the second wireless charging module.

Advantageously, the second wireless charging module comprises:
a housing;
a wireless charging coil disposed in the housing; and
a first electrical contact guide column disposed below the housing, electrically connected to the wireless charging coil, and inserted in the support rod from the top of the support rod;
and
a second electrical contact guide column electrically connected to the wireless charging circuit board, inserted in the support rod from the bottom of the support rod, and electrically connected to the first electrical contact guide column is fixed on the base.

Advantageously, a pair of electrical contact plates are respectively fixed at the bottom in the support rod and the top thereof, the two electrical contact plates are connected to each other via a wire, and the first electrical contact guide column and the second electrical contact guide column are respectively point-contacted with the electrical contact plate.

Advantageously, each of the first electrical contact guide column and the second electrical contact guide column comprises a body and an electrical conductor, at least one sliding slot is disposed on the body, and a sliding rod fit with the sliding slot is disposed on inner wall of the support rod.

Advantageously, an antiskid pad is fixed below the base, and another antiskid pad is disposed below the first wireless charging module in the base.

Advantages of the invention are that, the invention is a dual charging mode wireless charging device comprising the first wireless charging module and the charging stand, and can charge different types of electric devices; particularly, it is possible to place a headset on the charging device, and to charge the headset wirelessly.

### BRIEF DESCRIPTION OF THE DRAWINGS

FIG. 1 is a schematic view of a wireless charging device of an exemplary embodiment of the invention;

FIG. 2 is an exploded view of a wireless charging device of the invention; and

FIG. 3 is a sectional view at a support rod of the invention.

### DETAILED DESCRIPTION OF THE INVENTION

Detailed description of the invention will be given below in conjunction with accompanying drawings and specific embodiments. It should be noted that the embodiments are only meant to explain the invention, and not to limit the scope of the invention.

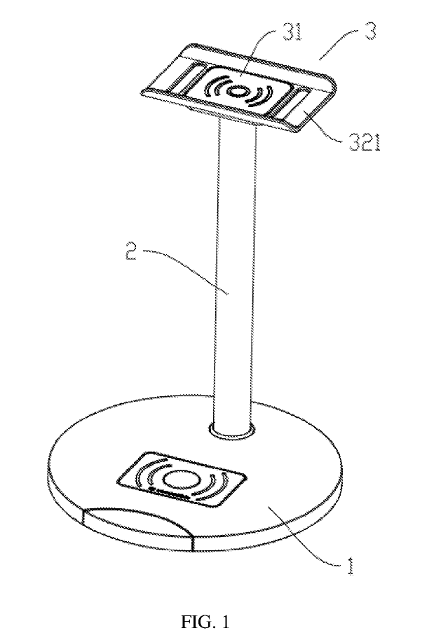

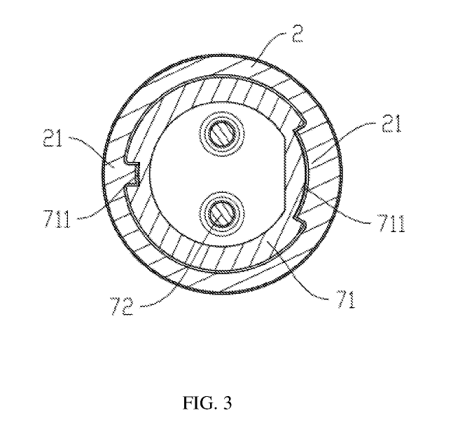

As shown in FIGS. 1 to 3, a wireless charging device of the invention comprises a base 1, a support rod 2 and a charging stand 3. The base 1 is a shell with a hollow cavity, the support rod 2 is hollow, and an antiskid pad 4 is disposed below the shell. A wireless charging circuit board 5 and a first wireless charging module 6 are disposed in the hollow cavity of the base 1. The wireless charging circuit board 5 is connected to a charging interface 51, and the charging interface 51 is disposed on a dorsal side of the base 1. The wireless charging circuit board 5 and the first wireless charging module 6 are electrically connected to each other. The charging stand 3 is supported by the support rod 2 and suspends, and is connected to the wireless charging circuit board 5 via the support rod 2. The charging stand 3 comprises a second wireless charging module 31 and a support plate 32, and each of the first wireless charging module 6 and the second wireless charging module 31 has a wireless charging coil.

Design of the second wireless charging module 31 and the support plate 32 is described hereinafter. The second wireless charging module 31 comprises a housing 311 and a wireless charging coil (not shown) disposed in the housing 311. A first electrical contact guide column is disposed below the housing 311, electrically connected to a wireless charging coil of the second wireless charging module 31, and inserted in the support rod 2 from the top of the support rod 2. The first electrical contact guide column comprises a body 71 and an electrical conductor 72. Fixing between the housing 311 and the first electrical contact guide column can be as follows, but is not limited thereto: the body 71 of the first electrical contact guide column and the housing 311 are integrally formed, alternatively, the body 71 and the housing 311 are individual parts fixed altogether via screws or other possible means.

The support plate 32 is fit on the housing 311, but fixing therebetween is not limited to this. The support plate 32 is made of flexible glue. In this embodiment, the support plate 32 comprises a fixing part and a peripheral part 321, the fixing part is fixed to the housing 311, and an area of the support plate 32 is greater than a surface area of the second wireless charging module 31. Therefore, as a non-limited embodiment, the charging stand is particularly applicable for charging a headset since it can form a headset holder and charge the headset wirelessly. In addition, as a wearing part of the headset employs arc-shaped design, the support plate made of flexible glue is perfectly usable for wireless charging of not only a mobile phone product, but also the headset.

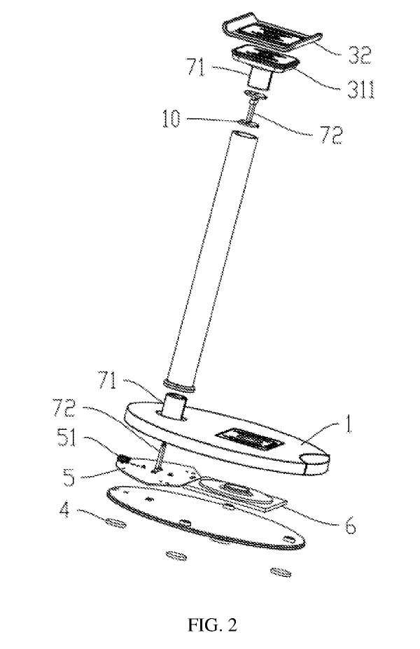

Meanwhile, a second electrical contact guide column is fixed on the base 1, electrically connected to the wireless charging circuit board 5, and inserted in the support rod 2 from the bottom of the support rod 2. Thus the first electrical contact guide column corresponds to the second electrical contact guide column. Preferably, a pair of electrical contact plates 10 are respectively fixed at the bottom in the support rod 2 and the top thereof (as shown in FIG. 2, it should be noted that the electrical contact plate fixed at the bottom in the support rod 2 is not shown), and connected to each other via a wire. The first electrical contact guide column and the second electrical contact guide column are respectively point-contacted with the electrical contact plate 10.

Being identical to the first electrical contact guide column, the second electrical contact guide column comprises a body 71 and an electrical conductor 72. Fixing between the housing 311 and the first electrical contact guide column can be as follows, but is not limited thereto: the body 71 of the first electrical contact guide column and the housing 311 are integrally formed, alternatively, the body 71 and the housing 311 are individual parts fixed altogether via screws or other possible means.

Therefore, by using the first electrical contact guide column and the second electrical contact guide column, the support rod can be removably assembled or disassembled, so that the base, as well as the wireless charging circuit board and the first wireless charging module disposed in the base form a thin plate-type wireless charging plate, namely an existing and normal wireless charger.

Particularly, at least one sliding slot 711 is disposed on the body 71, and a sliding rod 21 fit with the sliding slot 711 is disposed on inner wall of the support rod 2, making it possible to removably assemble or disassemble the support rod, and to prevent rotation of the support rod 2.

While preferred embodiments of the invention have been described above, the invention is not limited to disclosure in the embodiments and the accompanying drawings. Any changes or modifications without departing from the spirit of the invention fall within the scope of the invention.

What is claimed is:

1. A wireless charging device, comprising a base, as well as a wireless charging circuit board and a first wireless charging module disposed in said base, wherein said device further comprises:
a support rod fixed by said base; and
a charging stand supported by said support rod, and electrically connected to said wireless charging circuit board.

2. The wireless charging device of claim 1, wherein said charging stand comprises:
a second wireless charging module operating to emit an electromagnetic field; and
a support plate made of flexible glue and fixed on said second wireless charging module, an area thereof being greater than a surface area of said second wireless charging module.

3. The wireless charging device of claim 2, wherein
said second wireless charging module comprises:
a housing;
a wireless charging coil disposed in said housing; and
a first electrical contact guide column disposed below said housing, electrically connected to said wireless charging coil, and inserted in said support rod from the top of said support rod;
and
a second electrical contact guide column electrically connected to said wireless charging circuit board, inserted in said support rod from the bottom of said support rod, and electrically connected to said first electrical contact guide column is fixed on said base.

4. The wireless charging device of claim 3, wherein
a pair of electrical contact plates are respectively fixed at the bottom in said support rod and the top thereof;
said two electrical contact plates are connected to each other via a wire; and
said first electrical contact guide column and said second electrical contact guide column are respectively point-contacted with said electrical contact plate.

5. The wireless charging device of claim 3, wherein
each of said first electrical contact guide column and said second electrical contact guide column comprises a body and an electrical conductor;
at least one sliding slot is disposed on said body; and
a sliding rod fit with said sliding slot is disposed on inner wall of said support rod.

6. The wireless charging device of claim 1, wherein
an antiskid pad is fixed below said base; and
another antiskid pad is disposed below said first wireless charging module in said base.
